(19) United States
(12) Patent Application Publication
(10) Pub. No.: US 2013/0223093 A1
(43) Pub. Date: Aug. 29, 2013

(54) LIGHT-CONCENTRATIVE ILLUMINATING KEYBOARD

(71) Applicant: Chin-Wen CHOU, New Taipei City (TW)

(72) Inventor: Chin-Wen CHOU, New Taipei City (TW)

(73) Assignee: ZIPPY TECHNOLOGY CORP.

(21) Appl. No.: 13/407,299

(22) Filed: Feb. 28, 2012

(51) Int. Cl. F21V 7/04

(52) U.S. Cl. 362/602

(57) ABSTRACT

A light-concentrative illuminating keyboard contains a keyboard set and at least one illuminating set. The keyboard set includes plural pressing members depressible to move based on a pressing direction, plural resilient supporting members disposed relative to the pressing members to allow the pressing members to move reciprocately along the pressing direction, and a circuit board to be triggered to generate an instruction signal while the pressing members presses the resilient supporting members individually. The circuit board includes at least one reflecting region at least relative to the resilient supporting member. The illuminating set is disposed in a light guiding space between the pressing members and the circuit board to generate light. The light is transmitted in the light guiding space and reflected by the reflecting region of the circuit board to guide into the pressing member through the resilient supporting member to provide high illumination.

### FIELD OF THE INVENTION

The present invention relates to illuminating keyboard, and more particularly to a light-concentrative illuminating keyboard.

### BACKGROUND OF THE INVENTION

Conventional computer apparatus, including desktop computer, laptop computer, notebook computer, and internet TV, etc., are widely used by people in daily life. A keyboard is used by user to input data or instruction into the computer apparatus. The keyboard is designed in various types based on different use requirements.

For example, a conventional keyboard with an illumination function has been disclosed in U.S. Pat. No. 6,284,988, U.S. Pat. No. 6,322,229, U.S. Pat. No. 6,199,996, U.S. Pat. No. 6,554,442, U.S. Pat. No. 6,179,432, and U.S. Pat. No. 6,987,466 to clearly view symbols on the keyboard in a low brightness circumstance or darkness and accurately stroke the keyboard. Such a conventional keyboard with the illumination function contains a built-in illuminating piece to emit light, thus obtaining the illumination function.

However, keycaps, resilient members, and driven mechanisms in the conventional keyboards mostly are made of a transparent material so when light emitting elements emit the light, the keyboard has an even backlight. But if the keyboard is operated in the low brightness circumstance or the darkness, such as in the plane or car, it emits the light evenly to interfere other people around the user. Furthermore, in the low brightness circumstance, because a visual ability of the user to the keyboard is decreased since the keyboard emits the light evenly, the user can not distinguish every keycap, and the light emitted between the keycaps also causes interference to make identification difficult, so a wrong instruction is usually inputted into the keyboard by the user.

To solve such a problem, an improved illuminated keyboard has been disclosed in U.S. Pat. No. 7,628,500, U.S. Pat. No. 7,588,338, U.S. Pat. No. 7,154,059, and US Publication No. 20110168538. Each keycap of the illuminated keyboard can be viewed clearly in darkness or the low brightness circumstance so that the user inputs an exact instruction. Nevertheless, the light projecting to a single key can not be emitted towards the keycap completely, and accordingly partial light is still transmitted towards a circuit board or a holding plate to cause uneven reflection or scattering, so halos appear around the keycap to reduce the brightness of the keycap.

The present invention has arisen to mitigate and/or obviate the afore-described disadvantages.

### SUMMARY OF THE INVENTION

The primary object of the present invention is to provide a light-concentrative illuminating keyboard that is capable of overcoming halos appearing around a keycap resulting from reflection and scattering of a part of light source and preventing from reducing brightness of the keycap.

To obtain the above objective, a measuring method for a light-concentrative illuminating keyboard provided by the present invention contains: a keyboard set and at least one illuminating set. The keyboard set includes a plurality of pressing members depressible to move based on a pressing direction, a plurality of resilient supporting members disposed relative to the plurality of pressing members to allow the plurality of pressing members to move reciprocately along the pressing direction, and a circuit board to be triggered to generate an instruction signal while the plurality of pressing members presses the plurality of resilient supporting members individually. The circuit board includes at least one reflecting region at least relative to the resilient supporting member. The illuminating set is disposed in a light guiding space between the plurality of pressing members and the circuit board to generate light. The light is transmitted in the light guiding space and reflected by the reflecting region of the circuit board to guide into the pressing member through the resilient supporting member to provide high illumination.

In one embodiment, the reflecting region fully covers the surface of the circuit board.

In one embodiment, the circuit board has a first electrode layer, a second electrode layer, and an insulation layer between the first electrode layer and the second electrode layer.

In one embodiment, each resilient supporting member includes a pressed deforming section and a holding section located around the pressed deforming section to hold the pressed deforming section.

In one embodiment, the illuminating set includes an opaque area and at least one transparent zone located on the opaque area. The transparent zone of the illuminating set is located relative to the plurality of resilient supporting members.

In one embodiment, the illuminating set includes a light guide element and an illuminating element to provide light for the light guide element. The illuminating element is an electroluminescent unit or a light emitting diode.

In one embodiment, the each resilient supporting member is made of a transparent material.

In one embodiment, the light-concentrative illuminating keyboard further comprises a base plate to support the keyboard set. The keyboard set includes a plurality of driven mechanisms connected with the plurality of pressing members and the base plate. Each driven mechanism is made of a transparent material.

In one embodiment, the illuminating set is formed in a pillared shape.

Thereby, the light-concentrative illuminating keyboard of the present invention is characterized in that the circuit board has a plurality of reflecting regions at least relative to the plurality of resilient supporting members so that the light projecting to the plurality of resilient supporting members but not to the plurality of pressing members is reflected to the plurality of pressing members by the reflecting regions to enhance illumination of the plurality of pressing members.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a partial perspective view showing the exploded components of a light-concentrative illuminating keyboard according to a preferred embodiment of the present invention.

FIG. 2 is a perspective view showing the exploded components of the light-concentrative illuminating keyboard according to the preferred embodiment of the present invention.

FIG. 3 is a cross sectional view showing the assembly of the light-concentrative illuminating keyboard according to the preferred embodiment of the present invention.

FIG. 4 is a cross sectional view showing the assembly of a light-concentrative illuminating keyboard according to another preferred embodiment of the present invention.

### DETAILED DESCRIPTION OF THE PREFERRED EMBODIMENTS

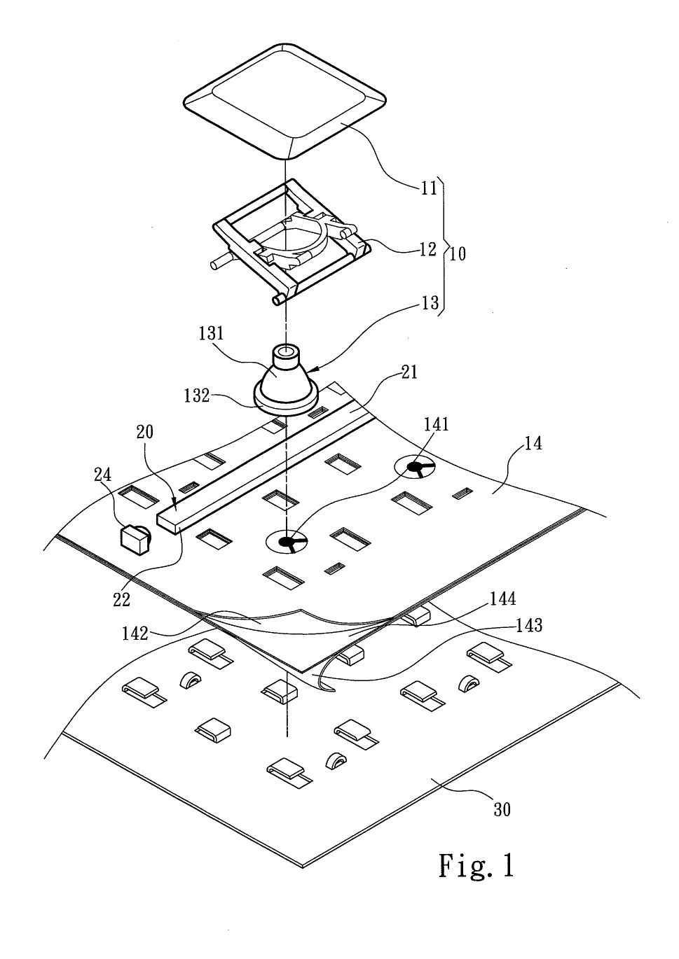

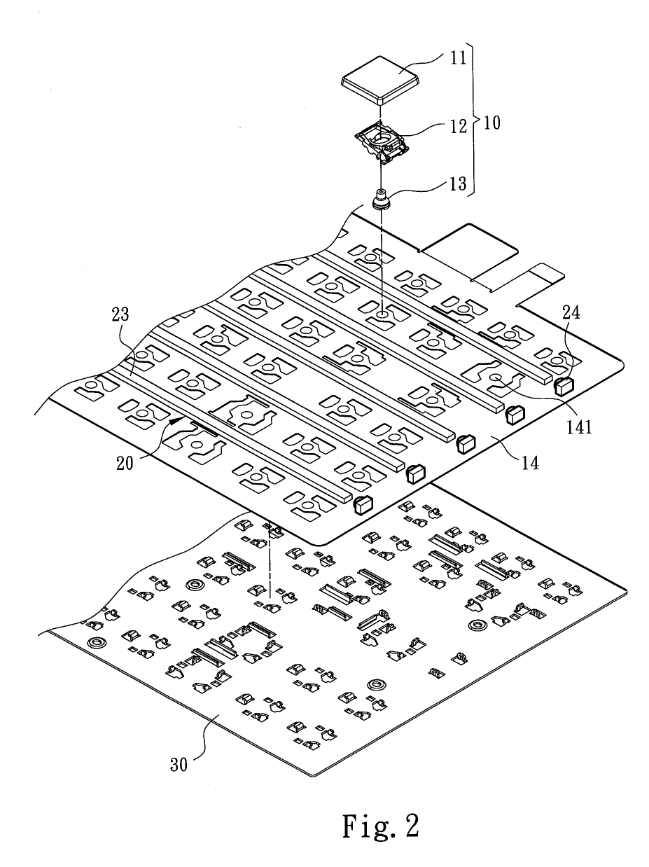

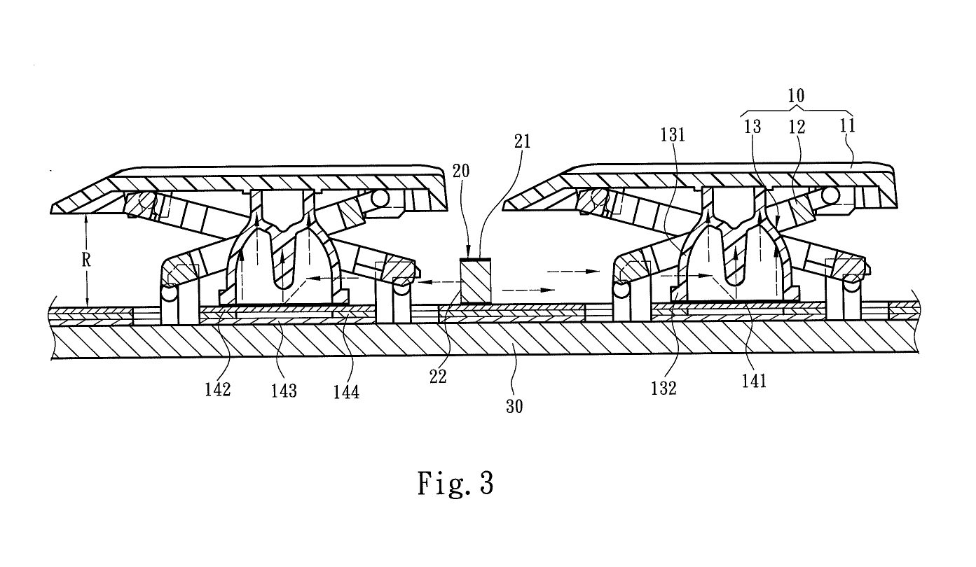

FIG. 1 is a partial perspective view showing the exploded components of a light-concentrative illuminating keyboard according to a preferred embodiment of the present invention, FIG. 2 is a perspective view showing the exploded components of the light-concentrative illuminating keyboard according to the preferred embodiment of the present invention, and FIG. 3 is a cross sectional view showing the assembly of the light-concentrative illuminating keyboard according to the preferred embodiment of the present invention. The light-concentrative illuminating keyboard comprises a keyboard set 10, at least one illuminating set 20, and a base plate 30 to support the keyboard set 10 and the at least one illuminating set 20. The keyboard set 10 includes a plurality of pressing members 11 depressible to move based on a pressing direction, a plurality of driven mechanisms 12 connected with the plurality of pressing members 11 and the base plate 30, a plurality of resilient supporting members 13 disposed in the driven mechanisms 12 individually relative to the plurality of pressing members 11 to allow the plurality of pressing members 11 to move reciprocately along the pressing direction, and a circuit board 14 to be triggered to generate an instruction signal while the plurality of pressing members 11 presses the plurality of resilient supporting members 13. Each resilient supporting member 13 includes a pressed deforming section 131 and a holding section 132 located around the pressed deforming section 131 to hold the pressed deforming section 131. In this embodiment, each driven mechanism 12 and each resilient supporting member 13 are made of a transparent material.

The circuit board 14 includes a plurality of reflecting regions 141 at least relative to the plurality of resilient supporting members 13. In this embodiment, the circuit board 14 is soft and is a plastic membrane switch which has a first electrode layer 142, a second electrode layer 143, and an insulation layer 144 between the first electrode layer 142 and the second electrode layer 143. When the first electrode layer 142 and the second electrode layer 143 are not pressed in a normal condition, they are separated by the insulation layer 144 without contacting with each other. Once the pressing member 11 is pressed by a user, the corresponding resilient supporting member 13 deforms to force the first electrode layer 142 to contact the second electrode layer 143, thus the instruction signal is generated. The reflecting region 141 can be disposed on the first electrode layer 142, the second electrode layer 143 or the insulation layer 144 based on use requirement.

The illuminating set 20 is disposed in a light guiding space R between the plurality of pressing members 11 and the circuit board 14 to generate light. In this embodiment, the illuminating set 20 is formed in a pillared shape, and a cress section of which can be circular, square, or triangle. The illuminating set 20 includes an opaque area 21 and at least one transparent zone 22 located on the opaque area 21. To provide the light to the plurality of pressing members 11, the transparent zone 22 of the illuminating set 20 is located relative to the plurality of resilient supporting members 13 so that the light of the illuminating set 20 is transmitted in the opaque area 21 and outputted to the plurality of resilient supporting members 13 through the transparent zone 22. The illuminating set 20 is a self-luminous device or a device comprising a light guide element 23 and an illuminating element 24 to provide light for the light guide element 23 in this embodiment, wherein the illuminating element 24 can be an electroluminescent unit or a light emitting diode. The light generated from the illuminating set 20 is transmitted to the plurality of resilient supporting members 13 within the light guiding space R, and then a part of the light passes through the plurality of resilient supporting members 13 to the plurality of pressing members 11 directly, and another part of the light is reflected by the reflecting region 141 of the circuit board 14 to guide into the plurality of pressing members 11 through the plurality of resilient supporting members 13 so that the plurality of pressing members 11 can have concentrative illumination.

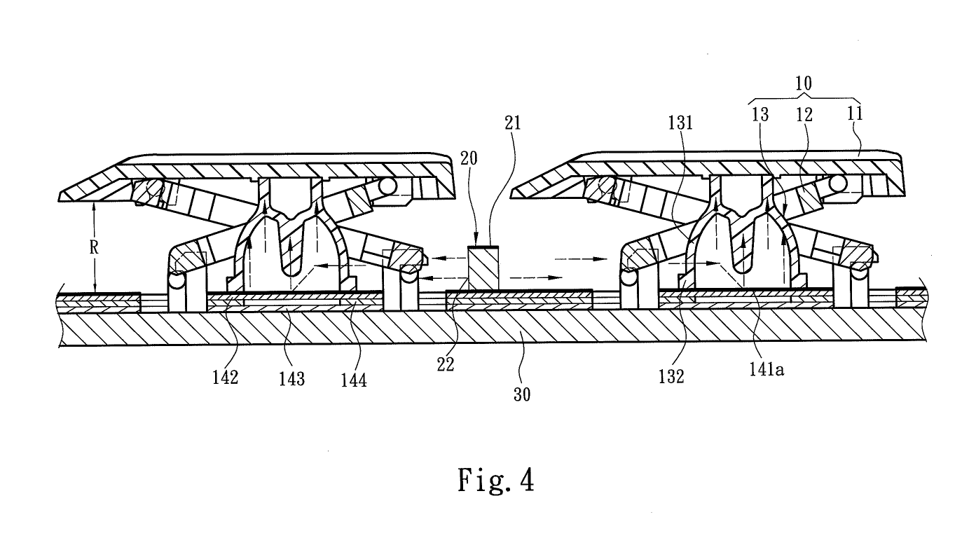

FIG. 4 is a cross sectional view showing the assembly of a light-concentrative illuminating keyboard according to another preferred embodiment of the present invention. The light-concentrative illuminating keyboard comprises a reflecting region 141 a fully covering the surface of the circuit board 14 so that the light generated from the illuminating set 20 is transmitted in the light guiding space R without passing through the circuit board 14, thus an even backlight on a bottom side of the keyboard is achieved. Thereby, the light is transmitted on one side of the circuit board 14 relative to the keyboard set 10 and then is reflected back to the plurality of resilient supporting members 13, enchanting brightness of the plurality of pressing members 11 above the plurality of resilient supporting members 13.

Thereby, the light-concentrative illuminating keyboard of the present invention provides a plurality of reflecting regions on the circuit board at least relative to the plurality of resilient supporting members so that a part of the light projecting to the plurality of resilient supporting members is transmitted towards the pressing members directly, and another part of the light is reflected to the plurality of pressing members by the reflecting regions to enhance illumination of the plurality of pressing members. Thus the light generated from the illuminating set can be transmitted to all pressing members 11 efficiently.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A light-concentrative illuminating keyboard, comprising:
a keyboard set including a plurality of pressing members depressible to move based on a pressing direction, a plurality of resilient supporting members disposed relative to the plurality of pressing members to allow the plurality of pressing members to move reciprocately along the pressing direction, and a circuit board to be triggered to generate an instruction signal while the plurality of pressing members pressing the plurality of resilient supporting members individually, the circuit board including at least one reflecting region at least relative to one of the plurality of resilient supporting members;
at least one illuminating set disposed in a light guiding space between the plurality of pressing members and the circuit board to generate light, the light being transmitted in the light guiding space and reflected by the reflecting region of the circuit board to guide into the pressing member through the resilient supporting member to provide high illumination.

2. The light-concentrative illuminating keyboard as claimed in claim 1, wherein the reflecting region fully covers a surface of the circuit board.

3. The light-concentrative illuminating keyboard as claimed in claim 1, wherein the circuit board includes a first electrode layer, a second electrode layer, and an insulation layer between the first electrode layer and the second electrode layer.

4. The light-concentrative illuminating keyboard as claimed in claim 3, wherein the reflecting region is disposed on the first electrode layer.

5. The light-concentrative illuminating keyboard as claimed in claim 3, wherein the reflecting region is disposed on the insulation layer.

6. The light-concentrative illuminating keyboard as claimed in claim 3, wherein the reflecting region is disposed on the second electrode layer.

7. The light-concentrative illuminating keyboard as claimed in claim 1, wherein the resilient supporting member includes a pressed deforming section and a holding section located around the pressed deforming section to hold the pressed deforming section.

8. The light-concentrative illuminating keyboard as claimed in claim 1, wherein the illuminating set includes an opaque area and at least one transparent zone located on the opaque area.

9. The light-concentrative illuminating keyboard as claimed in claim 8, wherein the transparent zone of the illuminating set is located relative to the plurality of resilient supporting members.

10. The light-concentrative illuminating keyboard as claimed in claim 1, wherein the illuminating set includes a light guide element and an illuminating element to provide light for the light guide element.

11. The light-concentrative illuminating keyboard as claimed in claim 10, wherein the illuminating element is an electroluminescent unit.

12. The light-concentrative illuminating keyboard 1 as claimed in claim 10, wherein the illuminating element is a light emitting diode.

13. The light-concentrative illuminating keyboard as claimed in claim 1, wherein the resilient supporting member is made of a transparent material.

14. The light-concentrative illuminating keyboard as claimed in claim 1 further comprising a base plate to support the keyboard set.

15. The light-concentrative illuminating keyboard as claimed in claim 14, wherein the keyboard set includes a plurality of driven mechanisms connected with the plurality of pressing members and the base plate.

16. The light-concentrative illuminating keyboard 1 as claimed in claim 15, wherein each of the plurality of driven mechanisms is made of a transparent material.

17. The light-concentrative illuminating keyboard as claimed in claim 1, wherein the illuminating set is formed in a pillared shape.
